(19) United States
(12) Patent Application Publication
(10) Pub. No.: US 2026/0345302 A1
(43) Pub. Date: Nov. 5, 2026

(54) IMAGING ALIGNMENT AIDE FOR DENTAL PROSTHESIS CONSTRUCTION UTILIZING A 3-D PATIENT MODEL

(71) Applicant: KLS-Martin L.P., Jacksonville, FL (US)

(72) Inventors: Baber KHATIB, Portland, OR (US); Craig Warren ENGEL, JR., Jacksonville, FL (US)

(21) Appl. No.: 19/663,612

(22) Filed: Apr. 30, 2026

Related U.S. Application Data
(60) Provisional application No. 63/797,476, filed on Apr. 30, 2025.

(51) Int. Cl. A61C 13/34; G06T 7/00

(52) U.S. Cl. CPC A61C 13/34; G06T 7/0012; G06T 2207/30036; G06T 2207/30204

(57) ABSTRACT

A 3-D model for a patient after resection of a portion of a maxilla or mandible may include a physical representation of a remainder of facial bones after resection of the portion of the maxilla or mandible of the patient, a fixation implant formed to define a reconstruction of the portion of the maxilla or mandible that is aligned with the remainder of the facial bones, a plurality of instances of a dental implant abutment operably coupled to the fixation implant, and an imaging reference aide overlaying and operably coupling to the plurality of instances of the dental implant abutment to provide one or more reference points for imaging. The fixation implant may be removably operably coupled with the 3-D model and may include harvested segments of fibula to recreate the portion of the maxilla or mandible. The imaging reference aide may be separate from the fixation implant.

### TECHNICAL FIELD

Example embodiments generally relate to an image alignment aide and, more particularly, relate to an imaging alignment aide to assist with production of a dental prosthesis and reconstruction implant.

### BACKGROUND

Certain patient diagnoses and/or facial injuries may require resection of a portion of the patent's maxilla or mandible. To ensure facial stability and appearance, a patient may receive an implant to reconstruct the resected portion. The implant may fill a gap in the patient's facial bone structure from the resection, as well as include tissue replacements and a dental prosthesis to return facial function.

However, given the complexity of the reconstruction and the number of necessary components/steps, dental prosthesis construction and its position relative the other components of reconstruction are critical to the success of the reconstruction. Current approaches estimate the position of a dental implant within the tissue being used for jaw/facial reconstruction prior to implant placement. This then requires completion of fabrication of the dental prosthetic within the operating room by attaching abutments (secured to the dental implant) to the premanufactured prosthetic with bonding resins. No method has been described to locate the exact position of the dental implant within as osseous free tissue transfer at the time of placement to then fabricate a dental prosthetic that can be attached directly to a dental implant with a fixation screw without the need for added resin bonds or a temporary abutments know as a “temporary coping”. As such, it may be desirable to manufacture or form the dental prosthesis after initial implant placement within a digital or physical model of the patient's now reconstructed facial bone structure once it is fixated to the remaining facial bone structure. Furthermore, given the precision necessary for the dental prosthesis formation, an imaging alignment aide for the digital/physical model may be desired to assist in creating the dental prosthesis design based on an updated scan of the implant.

### BRIEF SUMMARY OF SOME EXAMPLES

In accordance with an example embodiment, a 3-D model for a patient after resection of a portion of a maxilla or mandible may be provided. The 3-D model may include a physical representation of a remainder of facial bones after resection of the portion of the maxilla or mandible of the patient, a fixation implant formed to define a reconstruction of the portion of the maxilla or mandible that is aligned with the remainder of the facial bones, a plurality of instances of a dental implant abutment operably coupled to the fixation implant, and an imaging reference aide overlaying and operably coupling to the plurality of instances of the dental implant abutment to provide one or more reference points for imaging. The fixation implant may be removably operably coupled with the 3-D model and may include harvested segments of fibula to recreate the portion of the maxilla or mandible. The imaging reference aide may be separate from the fixation implant.

In another example embodiment, a method for facial reconstruction after resection of a portion of a maxilla or mandible may be provided. The method may include performing initial imaging of facial bones of a patient after resection of the portion of a maxilla or mandible, forming a physical representation of a remainder of facial bones after resection of the portion of the maxilla or mandible of the patient, forming a fixation implant to define a reconstruction of the portion of the maxilla or mandible that is aligned with the remainder of the facial bones, operably coupling a plurality of instances of a dental implant abutment to the fixation implant, overlaying and operably coupling an imaging reference aide to the plurality of instances of the dental abutment to provide one or more reference points for further imaging, forming a dental prosthesis to align and operably couple to the plurality of instances of the dental abutment, operably coupling the dental prosthesis to the fixation implant via the plurality of instances of the dental abutment to form a unitary implant, and operably coupling the unitary implant to the patient to replace the portion of the maxilla or mandible.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts a 3-D model and implant for a patient in accordance with an example embodiment;

FIG. 2 illustrates a 3-D model and implant for a patient in accordance with an example embodiment;

FIG. 3 depicts a perspective view of the 3-D model in accordance with an example embodiment;

FIG. 4 illustrates a front view of the 3-D model in accordance with an example embodiment;

FIG. 5 depicts a perspective view of the imaging reference aide in accordance with an example embodiment;

FIG. 6 illustrates a front view of the imaging reference aide in accordance with an example embodiment;

FIG. 7 depicts a top view of the imaging reference aide operably coupled to the 3-D model in accordance with an example embodiment;

FIG. 8 illustrates a front view of the imaging reference aide operably coupled to the 3-D model in accordance with an example embodiment;

FIG. 9A depicts a first side view of the imaging reference aide operably coupled to the 3-D model in accordance with an example embodiment;

FIG. 9B illustrates a second side view of the imaging reference aide operably coupled to the 3-D model in accordance with an example embodiment;

FIG. 10 depicts a perspective view of the imaging reference aide operably coupled to the 3-D model in accordance with an example embodiment;

FIG. 11 illustrates a front, partially transparent view of the 3-D model and imaging reference aide in accordance with an example embodiment;

FIG. 12 depicts a lower view of the 3-D model and the dental prosthesis in accordance with an example embodiment;

FIG. 13 depicts a flow chart for a method for reconstructing the face of a patient after resection of a portion of the maxilla or mandible in accordance with an example embodiment

FIG. 14 illustrates a perspective view of the imaging reference aide in accordance with an example embodiment; and

FIG. 15 depicts a perspective view of the imaging reference aide in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Additionally, as used herein, terminology such as “about” and “substantially” should be understood to be definite approximations that account for variations in measurements that cannot be, or as one of skill in the art would appreciate, normally are not, measured precisely. Thus, for example, a parameter that is “about” or “substantially” a given value or a given characteristic should be understood to be sufficiently close to the given value or given characteristic such that performance of the object or product to which the parameter applies, from the perspective of one with ordinary skill in the art, is the same as though the object or product had precisely the given value or characteristic.

Some example embodiments described herein may address the issues described above. In this regard, for example, some embodiments may provide an imaging alignment aide of an implant for facial reconstruction surgery of a patient. As a result, the imaging alignment aide may improve implant integration within the patient.

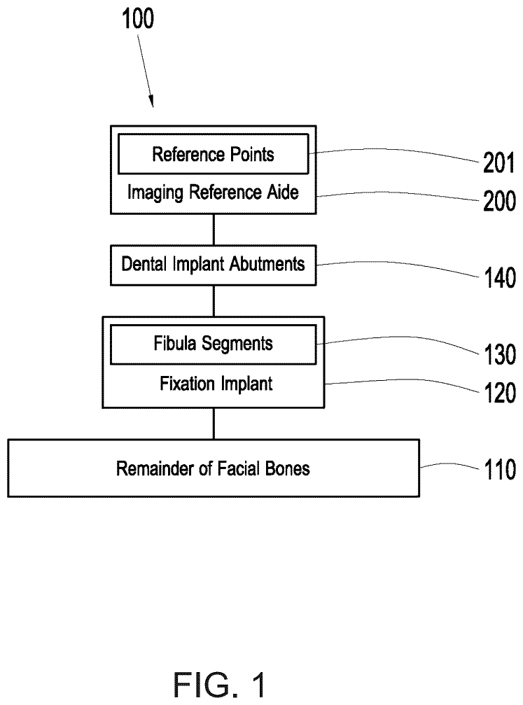

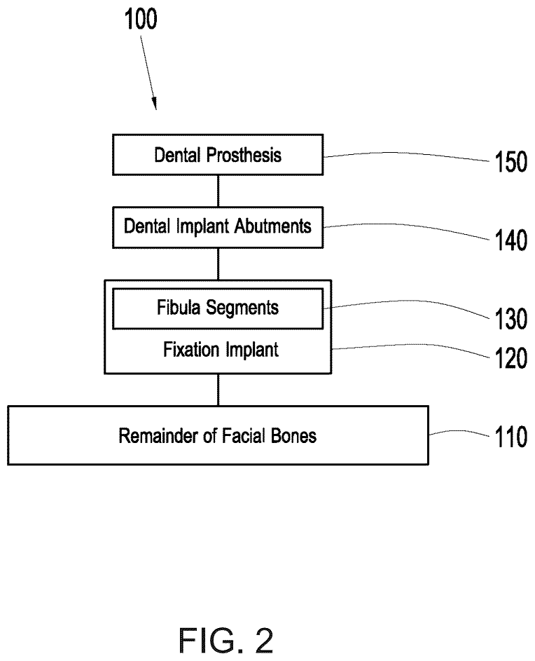

FIGS. 1 and 2 illustrate block diagrams of a 3-D model and implant for a patient in accordance with an example embodiment. In some cases, a 3-D model 100 of a patient after resection of a portion of the patient's jawbone may be created to assist in implant design finalization and positioning. The jawbone of the patient may include but is not limited to a mandible, maxilla, upper jaw, and/or lower jaw. The 3-D model 100 may include a remainder of facial bones 110 of the patient after resection of the portion of the patient's jawbone and a fixation implant 120 to help replace/reconstruct the portion of the patient's jawbone. The 3-D model 100 may be formed via 3D-printing utilizing imaging of the patient both before and after resection of the portion of the patient's jawbone. The imaging of the patient may include scans, grammetry, photogrammetry, X-rays, and other imaging techniques that may provide an accurate representation of the patient's facial geometry.

Depending on the degree of resection and the portion of the patient's jawbone resected, a tissue replacement may be incorporated within the fixation implant 120. In some cases, tissue from alternative locations on the patient's body may be utilized to assist in the facial reconstruction. For example, fibula segments 130 may be harvested as a tissue replacement for tissue of the previously resected portion of the patient's jawbone. The fibula tissue may share similar vascular and structure of the previously resected tissue, and thus integrate relatively easily with the remaining facial tissue. Other tissue may include the scapula, iliac crest, rib, radial or ulnar bone or any osseous free tissue transfer or non-vascularized tissue transfer.

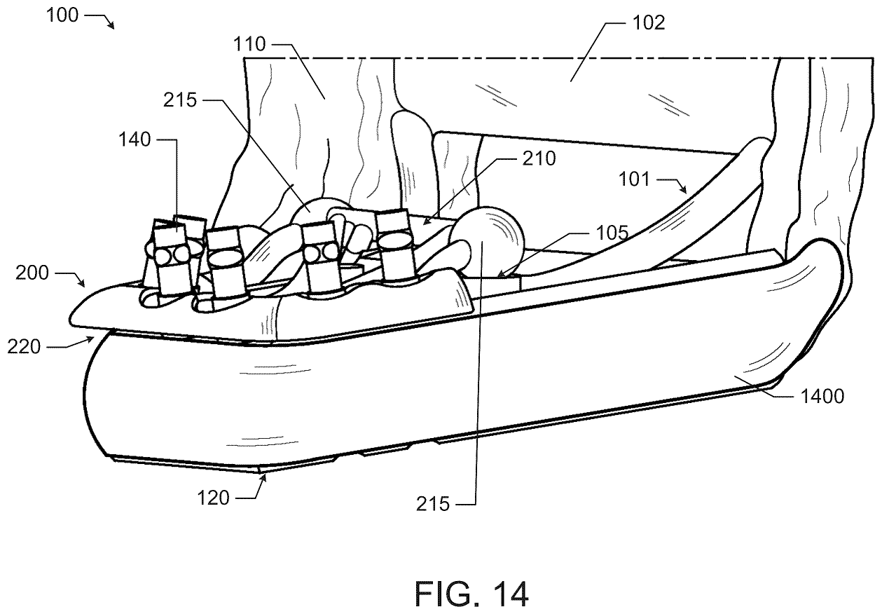

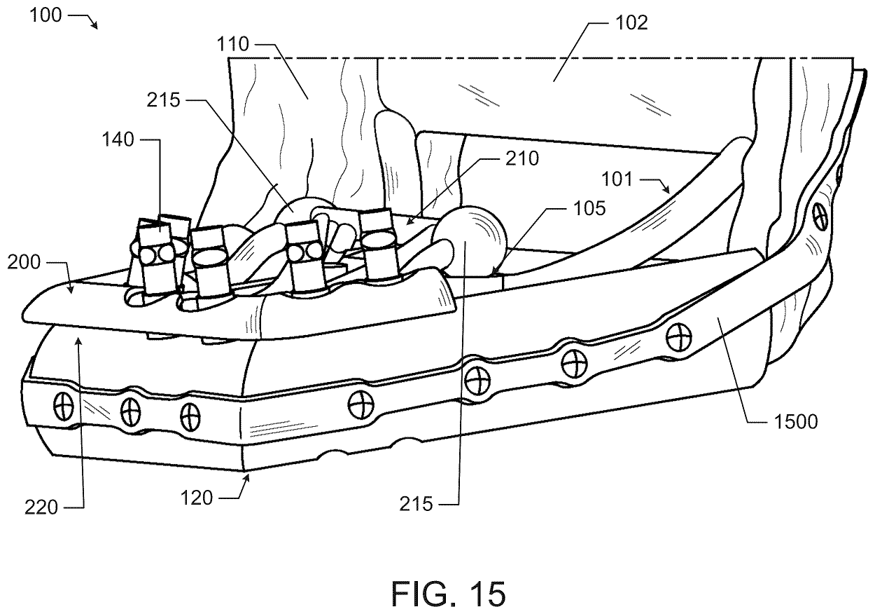

The fixation implant 120 may form a frame or base for the reconstruction. In this regard, FIGS. 14 and 15 illustrate examples of a plate 1400 and a brace 1500, respectively, which may form the frame or base. The fixation implant 120 may generally align with and complete the remainder of the facial bones 110 to create the outline or framework of the jawbone/jawbones. In some cases, the outline or framework of the jawbone may be trapezoidal to simplify, yet still mirror the jaw shape. In an example embodiment, dental implant abutments 140 may operably couple with the fixation implant 120 to operably couple a dental prosthesis 150 to the fixation implant 120 and thus the patient. The dental implant abutments 140 may include a plurality of instances of an individual dental implant abutment. The dental prosthesis 150 may have corresponding coupling interfaces that engage and secure the dental prosthesis 150 to the dental implant abutments 140. In some cases, the dental implant abutments 140 may extend through the fixation implant 120 and the fibula segments 130.

In an example embodiment, prior to the operable coupling of the dental prosthesis 150 to the dental implant abutments 140, an imaging reference aide 200 may operably couple with the dental implant abutments 140. The imaging reference aide 200 may overlay the dental implant abutments 140. In some cases, the imaging reference aide 200 may be separate from the fixation implant 120 and thus the fibula segments 130. In this regard, the imaging reference aide 200 may only engage with the fixation implant 120 via the dental implant abutments 140.

The imaging reference aide 200 may have a similar profile to the fixation implant 120 and the dental prosthesis 150. For example, the imaging reference aide 200 may extend in an arcuate shape similar to jawbone and tooth structure of the patient. The imaging reference aide 200 may include reference points 201. The reference points 201 may allow for accurate and complex imaging of the fixation implant 120 after the addition of the fibula segment 130 or other tissue segment and within the remainder of the facial bones 110 of the 3-D model 100. As the 3-D model 100 is merely a physical, printed model of the patient's facial structure disposed away from the patient, there may be an inherent lack of standard imaging reference points used for typical patient imaging (e.g. such as the imaging performed prior to resection).

As the precision required for an implant assembly is high, the operable coupling of the fixation implant 120, the fibula segment 130, and the dental implant abutments 140 to one another may occur prior to production or formation of the dental prosthesis 150. In this regard, the dental prosthesis 150 may be formed intraoperatively. To have the most accurate and stable dental prosthesis 150, updated imaging may occur of the 3-D model 100. Thus, the imaging reference aide 200 and its reference points 201 may assist in providing the necessary landmarks within the updated imaging/scans. The reference points 201 may provide reproducible landmarks for a scanner to register fiducial landmarks for the design dental prosthesis of the dental prosthesis 150. In some cases, the updated imaging may require the combination of multiple, separate images/scan with one another. For example, a controller may need to combine scans of each lateral side of the 3-D model 100 to properly represent the 3-D model 100. After the updated scanning/imaging, the dental prosthesis 150 may be printed, milled, or formed based on the updated 3-D model 100 after integration of the fibula segment 130.

After creation of the dental prosthesis 150, the imaging reference aide 200 may be removed from the 3-D model 100 and the dental implant abutments 140 and replaced by the dental prosthesis 150. As a result, the fixation implant 120, the fibula segments 130, the dental implant abutments 140, and the dental prosthesis 150 may form a single, unitary implant. The unitary implant may be inserted into the patient to replace the resected portion of the jawbone.

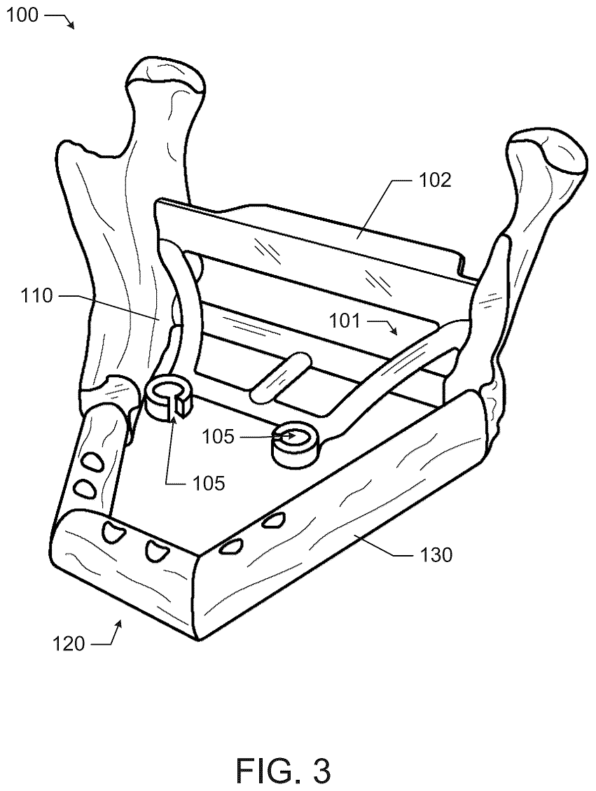

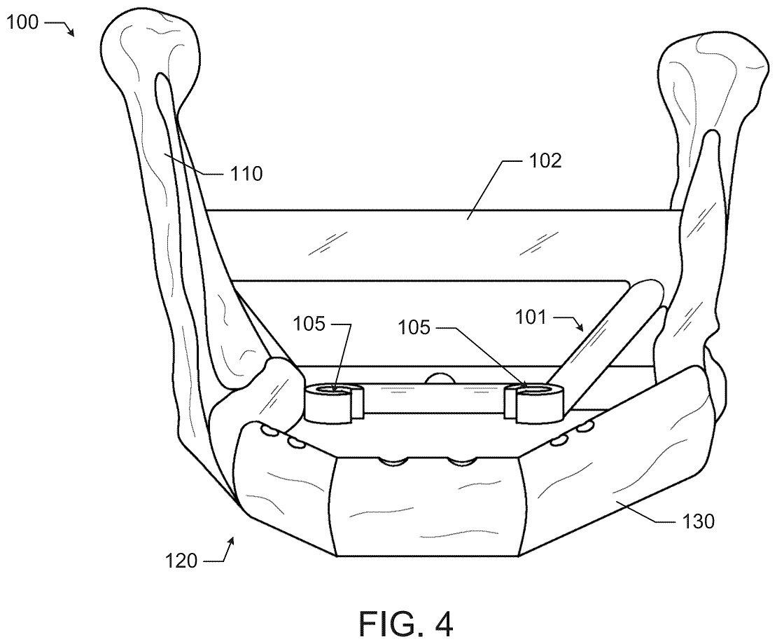

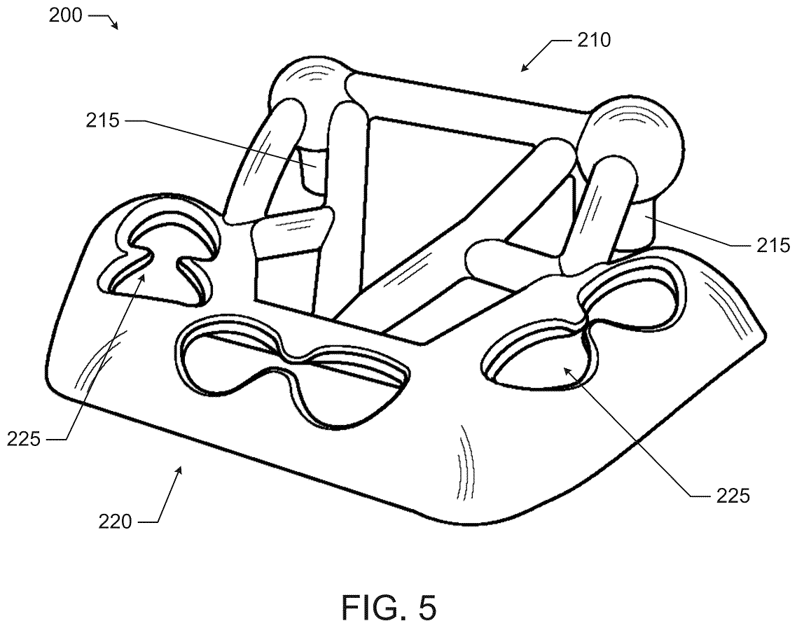

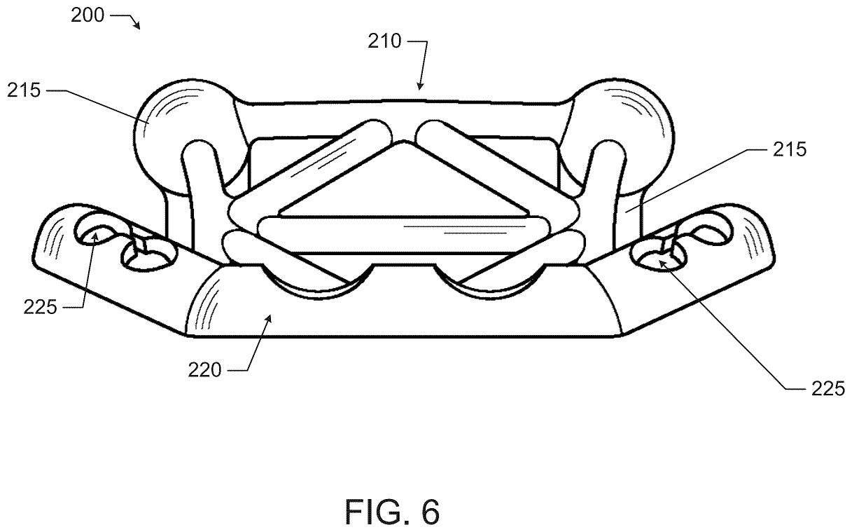

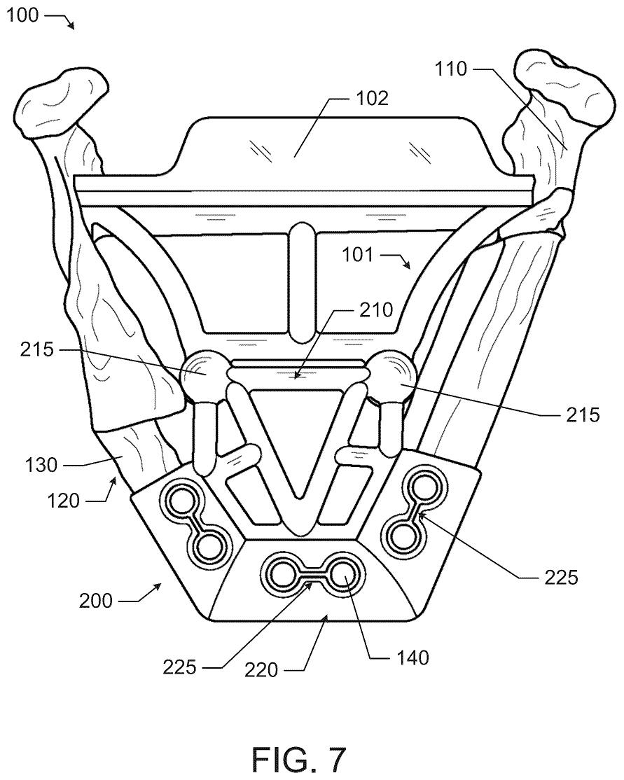

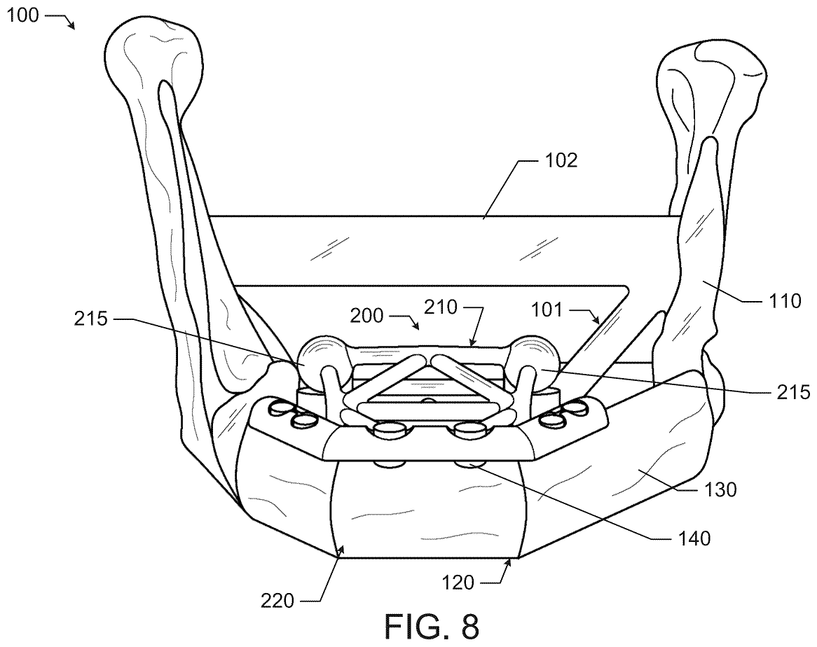

FIGS. 3 and 4 illustrate perspective and front views of the 3-D model respectively in accordance with an example embodiment. FIGS. 5 and 6 illustrate perspective and front views of the imaging reference aide respectively in accordance with an example embodiment. FIGS. 7 and 8 depict top and front views of the imaging reference aide operably coupled to the 3-D model respectively in accordance with an example embodiment. As shown in FIGS. 3 and 4, the remainder of facial bones 110 may not be symmetrical on each lateral side of the 3-D model 100. For example, the portion of the jawbone resected may not be laterally centered within the patient, and thus within the 3-D model 100. As the resection portion of the jawbone may lack lateral centering, the fixation implant 120 may also lack lateral centering.

The fibula segments 130 may additionally lack centering within the 3-D model 100. The fibula segments 130 may be further divided into sub-segments for harvesting, instillation, and/or imaging portions. For example, multiple graft sub-segments may be seen in FIGS. 3-8 (e.g. sub-segment A, sub-segment B, and sub-segment C). The number of sub-segments identified may vary depending on the patient and the fixation implant 120. In some cases, if only a minimal portion of the jawbone was resected, no sub-segmentation may be needed.

The 3-D model 100 may also include a support portion 101. The support portion 101 may be disposed between lateral sides of the remainder of facial bones 110. The support portion 101 may include a lateral support bar 102. The lateral support bar 102 may add stability to the 3-D model 100 itself, as well as may add an additional visual reference and structure for updating imagery of the 3-D model 100. The lateral support bar 102 may also add patient identification information to ensure the correct pairing of the 3-D model 100 and the patient.

In some cases, the support portion 101 may include at least one receiving orifice 105 to assist in operably coupling the imaging reference aide 200 to the 3-D model 100. The imaging reference aide 200 may include an anchor portion 210 and an overlay portion 220. The anchor portion 210 may operably couple to the support portion 101, and the overlay portion 220 may operably couple to the dental implant abutments 140. The anchor portion 210 may operably couple with the support portion 101 via at least one coupling extension 215. The at least one coupling extension 215 of the anchor portion 210 may operably couple to corresponding ones of the at least one receiving orifice 105 of the support portion 101. The at least one coupling extension 215 may be a peg that extends through the at least one receiving orifice 105 to ensure stability of the imaging reference aide 200 throughout the updated imaging process.

In an example embodiment, the overlay portion 220 may include a plurality of corresponding receiving orifices 225 that correspond to the dental implant abutments 140. In some cases, the plurality of corresponding receiving orifices 225 may be paired with one another to correspond to a paired set of dental implant abutments 140. The overlay portion 220 may be an arcuate shape and extend around the fixation implant 120 and the dental implant abutments 140.

In an example embodiment, both the support portion 101 and the anchor portion 210 may include lattice structures to provide additional support to the 3-D model 100 and the imaging reference aide 200. The lattice structures may support the at least one coupling extension 215 and the at least one receiving orifice 105. In some cases, the lattice structures may also serve to provide additional visual references for the updated imaging of the 3-D model 100. The lattice structures may also help position and align the imaging reference aide 200. In an example embodiment, the anchor portion 210 and the majority of the lattice structure of the imaging reference aide 200 may be disposed further vertically away or superiorly from the fixation implant 120 and the dental implant abutments 140 than the overlay portion 220. In this regard, the majority of the structure of the imaging reference aide 200 may be visible throughout imaging instead of being positioned behind the remainder of the facial bones 110 or the fixation implant 120.

In some cases, the positioning of the imaging reference aide 200 may ensure the reference points 201 are sufficiently exposed and visible for imaging. The reference points 201 may include various reference markings and the various distinct shapes/structures of the imaging reference aide 200. For example, an instance of the reference points 201 may include a section of the at least one coupling extension 215. The coupling extension 215 may include a rounded or spherical end that may serve as one instance of the reference points 201. Another instance of the reference points 201 may be the lateral/horizontal reference ridge. The reference ridge may extend substantially parallel with the fixation implant 120 and/or an outer edge of the overlay portion 220 of the imaging reference aide 200. In an example embodiment, the imaging reference aide 200 may include text-branding. The text-branding instances may also double as reference points 201.

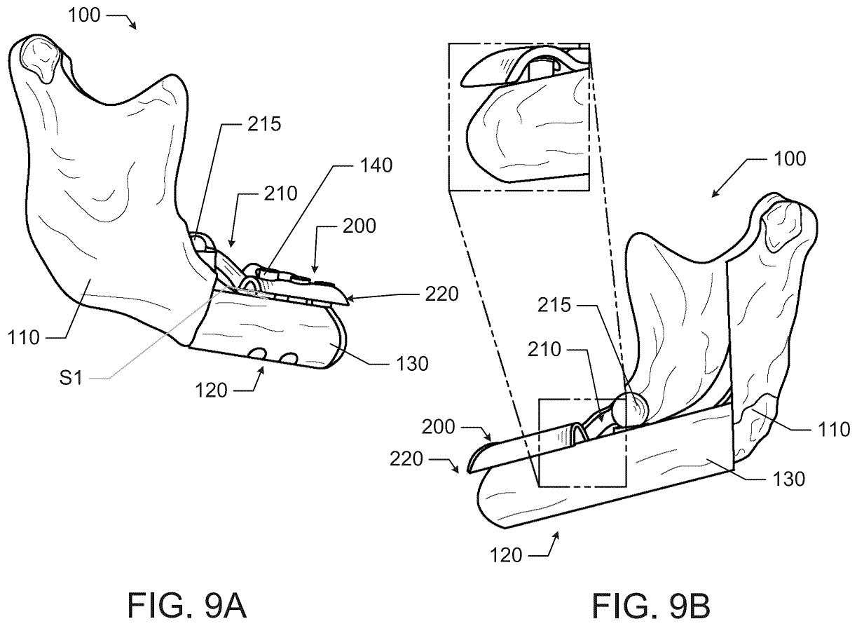

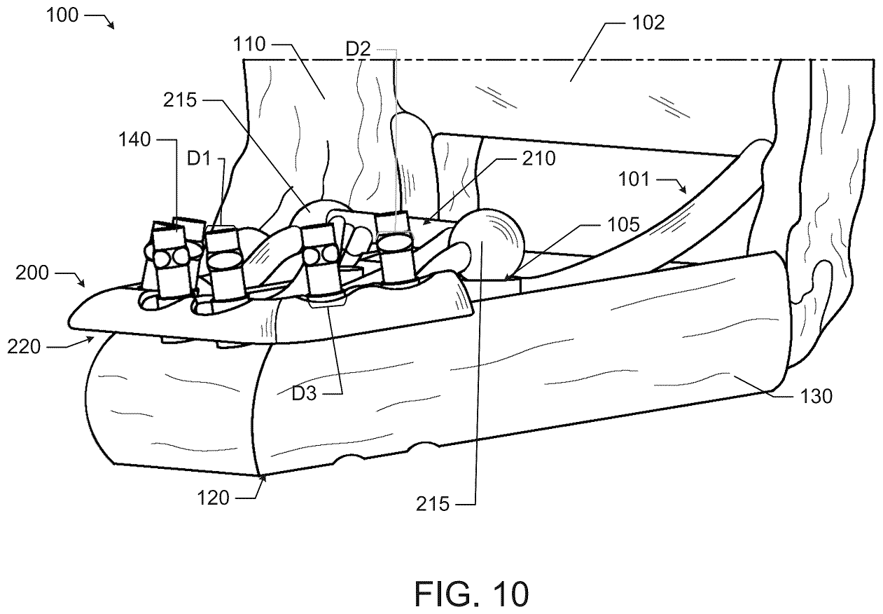

FIGS. 9 and 10 depict lateral side and perspective views of the imaging reference aide operably coupled to the 3-D model in accordance with an example embodiment. As seen in FIGS. 9 and 10, the imaging reference aide 200 may be separated from the fixation implant 120, and thus may be separated from the fibula segments 130. As secure engagement and operable coupling of the fibula segments 130 and the dental prosthesis 150 is critical for implant stability/performance, the separation of the imaging reference aide 200 and the fibula segment 130 may ensure the entire fibula segments 130 may be imaged, as well as avoid unnecessary contact with the fibula segments 130 after harvesting. As seen in FIG. 9, the fibula segments 130 and the imaging reference aide 200 may be separated by a first separation distance S1.

In some cases, the imaging reference aide 200 may only overlay a portion of the fixation implant 120. The imaging reference aide 200 may extend enough to provide one or more reference point for each potential image or scan of the 3-D model 100. The imaging reference aide 200 may also rest on a wider portion of the dental implant abutments 140. The dental implant abutments 140 may taper various amounts at various locations along the length of the dental implant abutments 140. For example, as seen in FIG. 10, the dental implant abutments 140 may have a first diameter D1 along a majority of the length of the dental implant abutments 140. The dental implant abutments 140 may also have a second diameter D2 and a third diameter D3. The third diameter D3 may be larger than the second diameter D2 and may be disposed proximate the fixation implant 120. In this regard, the imaging reference aide 200 may pass/overlay beyond the second diameter D2 and rest on the dental implant abutments 140 at the third diameter D3. The dimensions of the dental implant abutments 140 may be intended for the coupling of the dental prosthesis 150, and the imaging reference aide 200 may be designed to utilize these dimensions for its overlaid functionality.

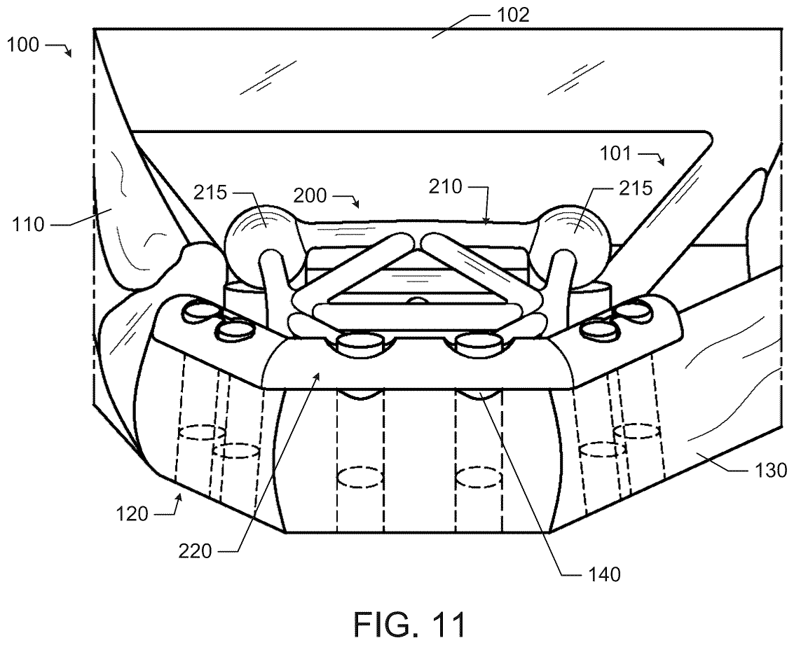

FIG. 11 depicts a front, partially transparent view of the 3-D model and imaging reference aide in accordance with an example embodiment. In some cases, the dental implant abutments 140 may extend completely through the fixation implant 120. The dental implant abutments 140 may be paired together and the pairs may be evenly distributed throughout the fixation implant 120. For example, each sub-section of the fixation implant 120 and fibula segments 130 may include a single pair of the dental implant abutments 140.

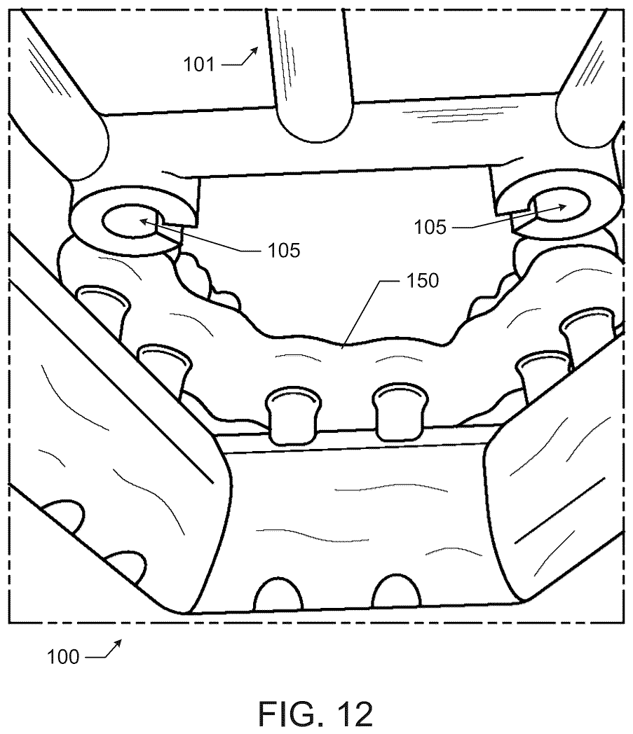

FIG. 12 depicts a lower view of the 3-D model and the dental prosthesis in accordance with an example embodiment. After imaging of the 3-D model 100 with the imaging reference aide 200, the dental prosthesis 150 may be formed and test-fit with the 3-D model 100 and the fixation implant 120. If the dental prosthesis 150 is satisfactory, the fixation implant 120, fibula segment 130, the dental implant abutments 140, and the dental prosthesis 150 may be unitarily implanted within the patient for facial reconstruction.

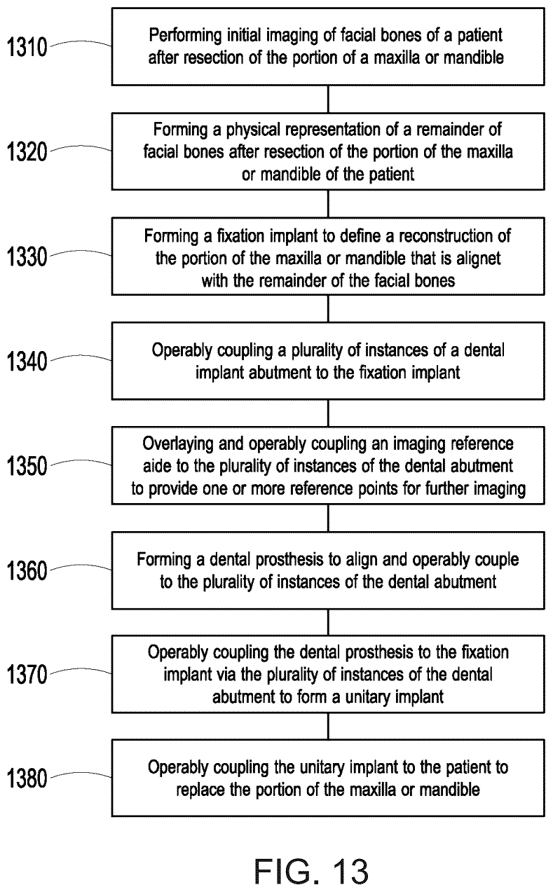

FIG. 13 depicts a method for reconstructing the face of a patient after resection of a portion of the maxilla or mandible. At step 1310, the method of facial reconstruction may perform initial imaging of facial bones of a patient after resection of the portion of a maxilla or mandible. At step 1320, the method may continue to form a physical representation of a remainder of facial bones after resection of the portion of the maxilla or mandible of the patient. At step 1330, the method may form a fixation implant to define a reconstruction of the portion of the maxilla or mandible that is aligned with the remainder of the facial bones. At step 1340, the method may operably couple a plurality of instances of a dental implant abutment to the fixation implant. At step 1350, the method may overlay and operably couple an imaging reference aide to the plurality of instances of the dental abutment to provide one or more reference points for further imaging. At step 1360, the method may form a dental prosthesis to align and operably couple to the plurality of instances of the dental abutment. At step 1370, the method may operably couple the dental prosthesis to the fixation implant via the plurality of instances of the dental abutment to form a unitary implant. At step 1380, the method may operably couple the unitary implant to the patient to replace the portion of the maxilla or mandible.

A 3-D model for a patient after resection of a portion of a maxilla or mandible may therefore be provided. The 3-D model may include a physical representation of a remainder of facial bones after resection of the portion of the maxilla or mandible of the patient, a fixation implant formed to define a reconstruction of the portion of the maxilla or mandible that is aligned with the remainder of the facial bones, a plurality of instances of a dental implant abutment operably coupled to the fixation implant, and an imaging reference aide overlaying and operably coupling to the plurality of instances of the dental implant abutment to provide one or more reference points for imaging. The fixation implant may be removably operably coupled with the 3-D model and may includes harvested segments of fibula to recreate the portion of the maxilla or mandible. The imaging reference aide may be separate from the fixation implant.

The implant for the face of the patient of some embodiments may include additional features, modifications, augmentations and/or the like to achieve further objectives or enhance performance of vehicle systems. The additional features, modifications, augmentations and/or the like may be added in any combination with each other. Below is a list of various additional features, modifications, and augmentations that can each be added individually or in any combination with each other. For example, the reference points may be reproducible landmarks for a scanner to register fiducial landmarks for a dental prosthesis design, and the reference points may be useable by a controller to combine two scans of each lateral side of the 3-D model. In some cases, the 3-D model may further include at least one receiving orifice disposed between lateral sides of the 3-D model, and the imaging reference aide may further include at least one coupling extension to operably couple to a corresponding instance of the at least one receiving orifice to anchor the imaging reference aide for the additional imaging. In an example embodiment, the at least one coupling extension may be disposed on an anchor portion of the imaging reference aide, and the imaging reference aide may operably couple to the plurality of instances of the dental abutment at an overlay portion. In some cases, the anchor portion may be disposed posteriorly compared to the overlay portion In an example embodiment, the at least one coupling extension of the anchor portion may be disposed superiorly compared to overlay portion. In some cases, the anchor portion may operably couple to the overlay portion at multiple coupling locations. In some cases, a base portion of the 3-D model may be trapezoidal. In an example embodiment, the plurality of instances of the dental abutment may extend through a plurality of corresponding receiving orifices of the imaging reference aide. In some cases, the imaging reference aide may further includes a reference ridge disposed substantially parallel to the fixation implant.

A method for facial reconstruction after resection of a portion of a maxilla or mandible may be provided. The method may include performing initial imaging of facial bones of a patient after resection of the portion of a maxilla or mandible, forming a physical representation of a remainder of facial bones after resection of the portion of the maxilla or mandible of the patient, forming a fixation implant to define a reconstruction of the portion of the maxilla or mandible that is aligned with the remainder of the facial bones, operably coupling a plurality of instances of a dental implant abutment to the fixation implant, overlaying and operably coupling an imaging reference aide to the plurality of instances of the dental abutment to provide one or more reference points for further imaging, performing the further imaging, forming a dental prosthesis to align and operably couple to the plurality of instances of the dental abutment, operably coupling the dental prosthesis to the fixation implant via the plurality of instances of the dental abutment to form a unitary implant, and operably coupling the unitary implant to the patient to replace the portion of the maxilla or mandible.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to difficulties are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A 3-D model for a patient after resection of a portion of a maxilla or mandible, the 3-D model comprising:
a physical representation of a remainder of facial bones after resection of the portion of the maxilla or mandible of the patient;
a fixation implant formed to define a reconstruction of the portion of the maxilla or mandible that is aligned with the remainder of the facial bones;
a plurality of instances of a dental implant abutment operably coupled to the fixation implant; and
an imaging reference aide overlaying and operably coupling to the plurality of instances of the dental implant abutment to provide one or more reference points for imaging,
wherein the fixation implant is removably operably coupled with the 3-D model and includes harvested segments of fibula to recreate the portion of the maxilla or mandible, and
wherein the imaging reference aide is separate from the fixation implant.

2. The 3-D model of claim 1, wherein the reference points are reproducible landmarks for a scanner to register fiducial landmarks for a dental prosthesis design, and
wherein the reference points are useable by a controller to combine two scans of each lateral side of the 3-D model.

3. The 3-D model of claim 1, wherein 3-D model further comprises at least one receiving orifice disposed between lateral sides of the 3-D model, and
wherein the imaging reference aide further comprises at least one coupling extension to operably couple to a corresponding instance of the at least one receiving orifice to anchor the imaging reference aide for the imaging.

4. The 3-D model of claim 3, wherein the at least one coupling extension is disposed on an anchor portion of the imaging reference aide, and
wherein the imaging reference aide operably couples to the plurality of instances of the dental abutment at an overlay portion.

5. The 3-D model of claim 4, wherein the anchor portion is disposed posteriorly compared to the overlay portion.

6. The 3-D model of claim 4, wherein the at least one coupling extension of the anchor portion is disposed superiorly compared to the overlay portion.

7. The 3-D model of claim 4, wherein the anchor portion is latticed, and
wherein the anchor portion operably couples to the overlay portion at multiple coupling locations.

8. The 3-D model of claim 1, wherein a base portion of the 3-D model is trapezoidal.

9. The 3-D model of claim 1, wherein the plurality of instances of the dental abutment extend through a plurality of corresponding receiving orifices of the imaging reference aide.

10. The 3-D model of claim 1, wherein the imaging reference aide further includes a reference ridge disposed substantially parallel to the fixation implant.

11. A method for facial reconstruction after resection of a portion of a maxilla or mandible, the method comprising:
performing initial imaging of facial bones of a patient after resection of the portion of a maxilla or mandible;
forming a physical representation of a remainder of facial bones after resection of the portion of the maxilla or mandible of the patient;
forming a fixation implant to define a reconstruction of the portion of the maxilla or mandible that is aligned with the remainder of the facial bones;
operably coupling a plurality of instances of a dental implant abutment to the fixation implant; and
overlaying and operably coupling an imaging reference aide to the plurality of instances of the dental abutment to provide one or more reference points for further imaging,
wherein the fixation implant is removably operably coupled with the 3-D model and includes harvested segments of fibula to recreate the portion of the maxilla or mandible, and
wherein the imaging reference aide is separate from the fixation implant.

12. The method of claim 11, further comprising performing the further imaging and responsive to the further imaging, forming a dental prosthesis to align and operably couple to the plurality of instances of the dental abutment.

13. The method of claim 12, wherein responsive to operably coupling of the dental prosthesis and the plurality of instances of the dental abutment, forming a unitary implant to include the dental prosthesis, the plurality of instances of the dental abutment, and fixation implant, and operably coupling the unitary implant to the patient to replace the portion of the maxilla or mandible.

14. The method of claim 11, wherein the reference points are reproducible landmarks for a scanner to register fiducial landmarks for a dental prosthesis design, and
wherein the reference points are useable by a controller to combine two scans of each lateral side of the physical representation.

15. The method of claim 11, wherein the physical representation further comprises at least one receiving orifice disposed between lateral sides of the physical representation, and
wherein the imaging reference aide further comprises at least one coupling extension to operably couple to a corresponding instance of the at least one receiving orifice to anchor the imaging reference aide for the further imaging.

16. The method of claim 15, wherein the at least one coupling extension is disposed on an anchor portion of the imaging reference aide, and
wherein the imaging reference aide operably couples to the plurality of instances of the dental abutment at an overlay portion.

17. The method of claim 16, wherein the anchor portion is disposed posteriorly compared to the overlay portion.

18. The method of claim 16, wherein the at least one coupling extension of the anchor portion is disposed superiorly compared to the overlay portion.

19. The method of claim 16, wherein the anchor portion is latticed, and
wherein the anchor portion operably couples to the overlay portion at multiple coupling locations.

20. The method of claim 11, wherein the imaging reference aide further includes a reference ridge disposed substantially parallel to the fixation implant.
